(19) United States
(12) Patent Application Publication
(10) Pub. No.: US 2015/0365375 A1
(43) Pub. Date: Dec. 17, 2015

(54) DELIVERY OF A MEDIA ITEM

(71) Applicants: NOKIA TECHNOLOGIES OY, Espoo (FI); NOKIA (CHINA) INVESTMENT CO., LTD., Daxing District, Beijing (CN)

(72) Inventors: Zhuoyuan LIAO, Beijiing (CN); Song LIU, Beijiing (CN); Bin GAO, Beijiing (CN); Jing WU, Beijiing (CN)

(21) Appl. No.: 14/764,391

(22) PCT Filed: Jan. 31, 2013
(86) PCT No.: PCT/CN2013/071182

§ 371 Date: Jul. 29, 2015

(51) Int. Cl. H04L 29/12; H04L 12/58

(52) U.S. Cl. CPC H04L 61/1582; H04L 51/28; H04L 51/10

(57) ABSTRACT

An approach for delivery and sharing a media item is provided. In an example embodiment, the approach provides a first arrangement that comprises obtaining one or more media items associated with a first client, obtaining one or more unique identifiers, each associated with at least one media item of the one or more media items and providing said one or more unique identifiers to at least one second client to enable identification of the one or more media items. In another example embodiment the approach further provides a second arrangement that comprises comprising obtaining one or more unique identifiers, each associated with at least one media item of one or more media items, wherein the one or more media items are associated with a first client, determining whether the one or more media items having said one or more unique identifiers associated therewith are already available for at least one second client at an apparatus, requesting, in response to one or more of the one or more media items having said one or more unique identifiers associated therewith not being available for the at least one second client at the apparatus, the respective one or more media items from the first client, and associating the one or more media items with said first client.

### TECHNICAL FIELD

The example and non-limiting embodiments of the present invention relate to delivery of a media item. In particular, at least some example embodiments relate to a method, an apparatus, a computer program and a system for delivering a media item having a unique identifier associated therewith. The media item may be an audio item, a video item, an image item, etc. In some example embodiments, the media item may be e.g. an audio or video item useable as a ringing indicator or an alert indicator of another type associated with a given user on basis of said unique identifier.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Modern computers and communication devices, such as laptop computers, desktop computers, mobile phones, internet tablets, gaming devices, etc. are capable of storing large databases of media data e.g. audio items, video items and/or digital images, etc. However, typically a given media item, e.g. a given song, a given video clip or a given image, available on a first device cannot be identified on a second device, even if the given media item is available as an exact copy of the respective media item in the first device. Consequently, identification of media items across separate devices is typically not possible without rather complex and/or proprietary procedures.

### SUMMARY

According to an example embodiment, an apparatus is provided, the apparatus comprising at least one processor and at least one memory including computer program code for one or more programs, the at least one memory and the computer program code configured to, with the at least one processor, cause the apparatus at least to obtain one or more media items associated with a first client, to obtain one or more unique identifiers, each associated with at least one media item of the one or more media items and to provide said one or more unique identifiers to at least one second client to enable identification of the one or more media items.

According to another example embodiment, another apparatus is provided, the apparatus comprising at least one processor and at least one memory including computer program code for one or more programs, the at least one memory and the computer program code configured to, with the at least one processor, cause the apparatus at least to obtain one or more unique identifiers, each associated with at least one media item of one or more media items, wherein the one or more media items are associated with a first client, to determine whether the one or more media items having said one or more unique identifiers associated therewith are already available for at least one second client at the apparatus, to request, in response to one or more of the one or more media items having said one or more unique identifiers associated therewith not being available for the at least one second client at the apparatus, the respective one or more media items from the first client and to associate the one or more media items with said first client.

According to another example embodiment, another apparatus is provided, the apparatus comprising means for obtaining one or more media items associated with a first client, means for obtaining one or more unique identifiers, each associated with at least one media item of the one or more media items, and means for providing said one or more unique identifiers to at least one second client to enable identification of the one or more media items.

According to another example embodiment, another apparatus is provided, the apparatus comprising means for obtaining one or more unique identifiers, each associated with at least one media item of one or more media items, wherein the one or more media items are associated with a first client, means for determining whether the one or more media items having said one or more unique identifiers associated therewith are already available for at least one second client at an apparatus, means for requesting, in response to one or more of the one or more media items having said one or more unique identifiers associated therewith not being available for the at least one second client at the apparatus, the respective one or more media items from the first client, and means for associating the one or more media items with said first client.

According to another example embodiment, a method is provided, the method comprising obtaining one or more media items associated with a first client, obtaining one or more unique identifiers, each associated with at least one media item of the one or more media items and providing said one or more unique identifiers to at least one second client to enable identification of the one or more media items.

According to another example embodiment, another method is provided, the method comprising obtaining one or more unique identifiers, each associated with at least one media item of one or more media items, wherein the one or more media items are associated with a first client, determining whether the one or more media items having said one or more unique identifiers associated therewith are already available for at least one second client at an apparatus, requesting, in response to one or more of the one or more media items having said one or more unique identifiers associated therewith not being available for the at least one second client at the apparatus, the respective one or more media items from the first client, and associating the one or more media items with said first client.

According to another example embodiment, a computer program is provided, the computer program including one or more sequences of one or more instructions which, when executed by one or more processors, cause an apparatus at least to obtain one or more media items associated with a first client, to obtain one or more unique identifiers, each associated with at least one media item of the one or more media items, and to provide said one or more unique identifiers to at least one second client to enable identification of the one or more media items.

According to another example embodiment, another computer program is provided, the computer program including one or more sequences of one or more instructions which, when executed by one or more processors, cause an apparatus at least to obtain one or more unique identifiers, each associated with at least one media item of one or more media items, wherein the one or more media items are associated with a first client, to determine whether the one or more media items having said one or more unique identifiers associated therewith are already available for at least one second client at an apparatus, to request, in response to one or more of the one or more media items having said one or more unique identifiers associated therewith not being available for the at least one second client at the apparatus, the respective one or more media items from the first client, and to associate the one or more media items with said first client.

The computer program and/or the another computer program may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for said computer program and/or said another computer program.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings.

FIG. 1 schematically illustrates an exemplifying arrangement.

FIG. 2 schematically illustrates a specially formatted SMS message in accordance with an example embodiment.

FIG. 3 schematically illustrates an example of information flow between a first client and a second client in accordance with an example embodiment.

FIG. 4 schematically illustrates an example of information flow between a first client and a second client in accordance with an example embodiment.

FIG. 5 schematically illustrates an example of information flow between a first client, a second client and a server in accordance with an example embodiment.

FIG. 6 schematically illustrates an example of information flow between a first client, a second client and a server in accordance with an example embodiment.

FIG. 7 illustrates a method in accordance with an example embodiment.

FIG. 8 illustrates a method in accordance with an example embodiment.

FIG. 9 schematically illustrates an exemplifying apparatus in accordance with an example embodiment.

### DESCRIPTION OF SOME EMBODIMENTS

FIG. 1 schematically illustrates an exemplifying arrangement 100 comprising a first client 120, a second client 140 and a server 160. The first client 120 is able to communicate with the second client 140 via a wireless and/or a wired network by transmitting and/or receiving data and signaling information. The first client 120 and the second client may be able to communicate, for example, via a cellular mobile network by using respective cellular protocols, such as GSM, UMTS, LTE, CDMA2000, etc. As another example, additionally or alternatively, the first client 120 may be able to communicate with the second client 140 via a packet switched network, such as a local area network (LAN), a wireless local area network (WLAN), the Internet, etc. As a further example, additionally or alternatively, the first client 120 and the second client 140 may be able to communicate over a link of other type, e.g. by using Bluetooth (BT) technology near field communication (NFC) technology or by using any other suitable communication means known in the art. The first and the second clients 120, 140 are preferably also able to communicate with the server 160 via a wireless and/or a wired network, for example via one of the type(s) described hereinbefore.

The example arrangement 100 provides a logical framework, components of which, i.e. the first client 120, the second client 140 and the server 160, may be embodied using one or more apparatuses. In particular, each of the components may be embodied by one or more apparatuses or as part of one or more apparatuses. However, typically, each client 120, 140 is embodied as a single apparatus or as a portion of a single apparatus. In one embodiment, a client 120, 140 may be embodied as a mobile device or as a portion thereof, wherein the mobile device is a mobile phone, a smartphone, a gaming device, a personal assistant, a music player, an internet tablet, a laptop computer. Generally, a client 120, 140 may be embodied as an apparatus or as a portion thereof capable of sending, receiving, processing and/or rendering media data, such as audio, video, synchronized audio and video, images, etc. In one example embodiment, the server 160 may be embodied as a single server apparatus, as one or more portions of a server apparatus, as a plurality of server apparatuses or as one or more portions of one or more server apparatuses. Each/any of the clients 120, 140 and the server 160 may be embodied in an apparatus by software means, by hardware means, or by a combination of software means and hardware means.

As a further example, the first client 120 and the second client 140 may be embodied or provided in the same apparatus or both the first client 120 and the second client 140 may be jointly provided in a group of two or more apparatuses. In this regard, the first client 120 may comprise e.g. a user account of a first user whereas the second client 140 comprises e.g. a user account of a second user. In fact, in such an approach the client 120, 140 may be at least in part independent of an apparatus such that a given user may use one of several apparatuses in order to access and activate his/her user account and hence access/activate the respective client 120, 140. This process may involve making use of resources available at the apparatus used for accessing/activating the user account and/or providing the apparatus with resources associated with the user account upon activation of the user account. As an example, such an account may be an email account, a telephone or a video telephony account, a(n instant) messaging account, an account for a social media service, etc. The first client 120 and the second client 140 may be available in the single apparatus or in the group of two or more apparatuses simultaneously or the availability may be restricted such that a given single apparatus or a given group of two or more apparatuses may provide only single client 120, 140 at a time.

The first client 120 is configured to obtain a media item. Obtaining the media item may comprise, for example, capturing a media item using suitable capturing means. This may involve capturing an audio signal using audio capturing means such as a microphone or a microphone array and arranging the audio signal into an audio file. Alternatively or additionally, as another example, capturing may comprise capturing a video signal using video capturing means such as a digital video camera and storing the captured signal as a video file or as an audio-visual file. As a further example, capturing may comprise capturing an image using image capturing means such as a digital (still) camera and storing the captured image as an image file. The first client 120 may comprise the capturing means or the first client 120 may have an access to and control over the capturing means.

Alternatively, obtaining the media item may comprise reading the media item from a memory, e.g. from a memory of an apparatus acting as or hosting the first client 120 or from a memory otherwise accessible by the first client 120 e.g. over a network.

The media item is preferably associated with a given user, typically with a user of the first client 120 or a user of an apparatus hosting the first client 120. The association between the media item and the user may be pre-arranged or the client 120 may be configured to associate a media item with the user e.g. on basis of input from the user. The media item may be inherently associated with the user, e.g. via the media item comprising an audio signal comprising the user's voice and/or a reference to the user, via the media item comprising video footage exhibiting the user or via the media item comprising an image depicting the user. Alternatively or additionally, the media item may be explicitly associated with the user, e.g. by the user or by another user explicitly associating a given media item to the user. Such an explicit association may be provided, for example, via an identifier associated with and/or allocated for the media item, as described in more detail hereinafter, and/or by providing the media item with metadata indicative of the association between the media item and the user.

The media item may be, additionally or alternatively, associated with a specific service or application, such as telephony service or application, a voice over IP (VoIP) service or application, a messaging service or application, an email service or application, etc. Typically, the association between a media item and a specific service or application is explicitly indicated, e.g. by providing the media item with metadata indicative of the association between the media item and the service or application.

The media item may be a general purpose media item suitable for various purposes. As non-limiting examples, such a general purpose media item may comprise an audio signal comprising a portion of user-recorded signal, for example the user's voice, a song or a portion thereof, or a portion of a movie soundtrack. Alternatively or additionally, the media item may comprise a video signal comprising user-recorded footage, a portion of a movie, a music video or a portion thereof, etc. Alternatively or additionally, the media item may comprise an image depicting the user or an item otherwise associated with the user, or the media item may be otherwise assigned to represent the user. Alternatively or additionally, the media item may comprise text or other string of characters descriptive of the user or otherwise associated with the user.

As another example, the media item may serve as a personalized alert tone or alert sound to indicate an event associated with the user of the first client 120 at the second client 140. As an example, the media item may be employed, in the second client 140, as a ringing tone and/or as a personalized video ringing tone that may be employed to indicate an incoming call or an incoming message from the user of the first client 120. Hereinafter, the term ringing tone is used for clarity and brevity of description to encompass various types of alert sounds. However, the concept of ringing tone should be interpreted broadly, covering any alert sound, visual indication, audio-visual indication, tactile indication, or a combination thereof, associated with user of the first client 120, e.g. an indication of an incoming message from the user of the first client 120, such as a short message service (SMS) message, a multimedia messaging service (MMS) message, an email message from the user of the of the first client 120, a facsimile message from the user of the first client 120, an instant message of an instant messaging service from the user of the first client 120, etc. The association between a media item and a user and the association between the media item and a service or application, as described hereinbefore, may be employed to indicate a given media item as a personalized ringing tone for a given user for a given service, e.g. as personalized ringing tone for indicating an incoming call from the given user or as a combination of an alert sound and an image for indicating an email message received from the given user.

As a further example, the media item comprising an image associated with a user of the first client 120 may be used an image representing the user of the first client 120 at the second client 140. The image may be displayed at the second device concurrently with playing back the ringing tone indicating an incoming call from said user of the first client 120. As another example, the image may be stored at the second client 140 as part of the contact information associated with said user of the first client 120 and hence e.g. to represent said user when a user of the second client 140 browses through the contact list.

As a yet further example, the media item comprising text or a string of characters may be employed to provide a personalized smiley associated with a user of the first client 120 at the second client 140 e.g. in an instant messaging message or in a text message such as an SMS message originating from said user of the first client 120.

In an example embodiment, the first client 120 is configured to obtain a unique identifier (UID) associated with the media item. The UID serves to uniquely identify the media item, either within a given context, e.g. within a database of media items, or globally. While globally unique ID would ensure correct identification of the media item independently of the context and usage scenario and hence could serve as a UID useable for several different purposes, in many practical purposes it may be sufficient to employ a UID that guarantees unique identification of the media item with which it is associated within a predetermined context.

In one example embodiment, obtaining the UID may comprise reading a predetermined UID associated with the media item from a memory together with the media item, provided e.g. as metadata associated with the media item. Alternatively, obtaining the UID may comprise determining the UID in accordance with a predetermined rule.

In one embodiment, determining the UID may comprise determining the UID based at least in part on one or more characteristics of the media item. Such characteristics may comprise one or more of the filename assigned to the media item, the length or size of the media item e.g. in bits, in bytes, in kilobytes, etc., the duration of the media item e.g. in seconds and/or in minutes, type of the media item (e.g. audio, video, video combined with audio, image, tactile output control data, etc.), metadata associated with the media item, etc. Example of pieces of information included in the metadata include, owner of the media item, originator of the media item, a name or another identifier assigned for the media item, time of creation of the media item, time and/or date of most recent modification of the media item, etc.

Alternatively or additionally, determining the UID may comprise determining the UID based at least in part on one or more characteristics of the user associated with the media item. Such characteristics may comprise one or more of the name, address, age, gender or nationality of the user, a username to a given service or account assigned to the user, an email address of the user, a group or association the user is assigned or belongs to, etc.

Instead of or in addition to using characteristics of the media item and/or the user associated with the media item as basis for determining the UID, the determination may comprise determining the UID on basis of data not directly associated with the media item or the user associated therewith, e.g. a block of random or pseudorandom data.

In an example embodiment, the UID is determined in accordance with a predetermined rule e.g. as a checksum computed according to a predetermined rule on basis of given source data, e.g. on basis of the one or more characteristics of the media item and/or user associated with the media item, possibly together with additional pieces of source data. As an example, a hash function, preferably a cryptographic hash function, may be employed as the predetermined rule for determining the UID on basis of the selected characteristics of the media item, the user associated with the media item and/or other source data. This typically serves to provide a UID having sufficient uniqueness.

An example of a suitable UID is the universally unique identifier (UUID) standardized by the open software foundation (OSF). The concept of the UUID is documented e.g. in International Telecommunication Union, Telecommunication Sector (ITU-T) Recommendation X.667 with the same documentation also provided under ISO/IEC 9834-8:2005, where ISO stands for International Organization for Standardization (ISO) and IEC stands for the International Electrotechnical Commission. Moreover, (technically) equivalent specification can be found in the Internet Engineering Task Force (IETF) Request for Comments (RFC) 4122. A UUID is a 128-bit number, typically presented in its canonical form as five groups of hexadecimal numbers with the groups separated by hyphens, the first group consisting of eight characters, the second, third and fourth groups consisting of four characters with the fifth group consisting of twelve characters, the presentation hence comprising 32 hexadecimal numbers/characters and four hyphens.

In an example embodiment, the first client 120 is configured to provide the UID associated with the media item to the second client 140 to enable identification of the media item by the second client 140 and/or to enable the second client 140 subsequently accessing the media item on basis of the value of the UID received at the second client 140. The first client 120 may be further configured to provide the media item with which the UID is associated together with the UID to the second client 140, as schematically illustrated in FIG. 3. While such provision of the media item in parallel with the respective UID may speed up provision of the media item, in general case it is preferred to first provide the UID only and provide the media item per request from the second client 140, as described in an example embodiment hereinafter in more detail.

According to an example embodiment, the first client 120 is configured to provide the UID to the second client 140 together with information indicative of an association between the media item and the first client 120 and/or an association between the media item and a user of the first client 120, to make the association between the media item corresponding to the UID and first client 120 and/or the user thereof explicit. As another example, in case the association between the media item and the first client 120 and/or a user thereof is directly derivable from the UID, explicit information indicative of association between the media item and the first client 120 and/or a user of the first client 120 may or may not be provided to the second client 140 together with the UID. The information indicative of association may be, for example, the name or other identifier of the first client 120 and/or the name of the user of the first client 120. Moreover, the UID may be provided to the second client 140 together with information indicative of association between the media item corresponding to the UID and an identification of the first client 120 and/or the user thereof in context of a service or application. Such identification may be for example the username of the client 120 and/or a user thereof for a given service or for a given application.

The UID, possibly accompanied by information linking the UID and the corresponding media item to a specific user and/or to a specific service or application, may be provided from the first client 120 to the second client 140 by any suitable transmission means. One example approach, however, comprises providing the UID as part of a vCard or xCard exchange, e.g. as a property or parameter of a vCard or an xCard, as defined e.g. in RFC 6350 and RFC 6351, respectively. Note that RFC 6350 defines version 4.0 of the vCard standard, with the versions 2.1 and 3.0 defined in RFC 2425 and RFC 2426, respectively. The information provided in the vCard or xCard exchange provides information of the client/user and hence serves as an explicit association between the client/user and the media item having the UID included in the vCard or xCard exchange associated therewith.

In one example embodiment, the UID may be provided by making use of a standard-defined property of the vCard or xCard standard for a purpose different from the one specified in the respective standard. While this provides sufficient interoperability with the clients 120, 140 that are configured to interpret such non-compliant use of a vCard or an xCard property in the same way, it does not ensure full interoperability with clients that are not configured to apply such use of the respective vCard or xCard property. Hence, according to an example embodiment, a dedicated property or parameter of a vCard or xCard is provided to enable communication of the UID from the first client 120 to the second client 140. As an example, such a property or parameter may be an additional standard property or parameter or an additional private extension identified with an “x-” prefix to distinguish it from the standard-defined properties or parameters.

In the following, an example of a vCard version 4.0 with a private extension for the media item employed as a ringing tone is provided (adapted on basis of the Wikipedia entry to the vCard, as retrieved from http://en.wikipedia.org/wiki/Vcard on 12 Dec. 2012).

BEGIN:VCARD

VERSION:4.0

N:Doe;John;;;

FN:Doe John

ORG:Example Corp.

TITLE:Jack of all trades

PHOTO:http://www.example.com/dir_photos/my_photo.gif

TEL;TYPE=“work,voice”;VALUE=uri:tel:+1-111-555-1234

TEL;TYPE=“home,voice”;VALUE=uri:tel:+1-404-555-3456

ADR;TYPE=work;LABEL=“42 Any St.\nAnytown, LA 30314\nUnited States of America”

:;;42 Any St.;Anytown;LA;30314;United States of America

EMAIL:john.doe@example.com

REV:20080424T195243Z

X-RING-TONE;VALUE=79054025255fb1a26e4bc422aef54eb4

END:VCARD

In the example above, the property “X-RING-TONE” exemplifies the usage of the private extension in the framework of the vCard version 4.0, with the other properties being used in accordance with RFC 6350. The value of the “X-RING-TONE” property may be provided as base64 encoded string of characters, as specified for example in RFC 4648, in order to facilitate information transfer across various types of networks. However, representation different from base64 encoding may be employed without departing from the scope of present invention.

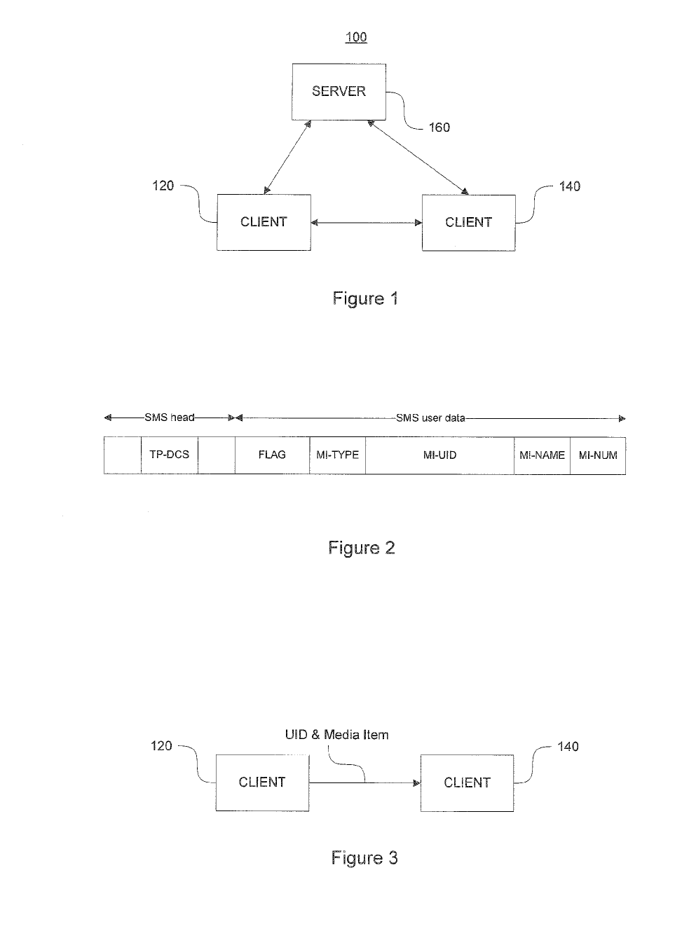

As another example, the UID may be provided in an SMS message or in a MMS message. As an example in this regard, a specially formatted SMS message may be employed to provide the UID, as schematically illustrated in FIG. 2. The exemplifying specially formatted SMS message illustrated in FIG. 2 is divided in the SMS header portion and the SMS user data portion. The SMS header portion comprises the TP-DCS field indicating the applied SMS data coding scheme (DCS), as specified e.g. in 3rd Generation Partnership Project (3GPP) technical specification (TS) 23.040. The value of the TP-DCS field is preferably set to 0x04. The SMS user data portion comprises at least the MI-UID field for carrying the UID, for example the UUID as described hereinbefore. The SMS user data portion may comprise further fields further characterizing the media item with which the UID is associated, as illustrated in FIG. 2. Namely, the SMS user data portion may comprise the FLAG field that may be employed e.g. to carry a transmission identifier, the MI-TYPE field that may be employed to specify the type of the media item and/or characteristics of the media item, the MI-NAME field that may be employed to carry the name of a user associated with the UID, and the MI-NUM field that may be employed to carry a phone number or an email address associated with the UID.

As a further example, the first client 120 may be configured to provide the UID, using appropriate, possibly proprietary, communication protocol, by email, by BT exchange, using NFC technology or by using any other suitable communication means known in the art. In another example embodiment, whether employing vCard or xCard exchange, specially formatted SMS message or another means for providing the UID to the second client 140, the first client 120 may be configured to push the data comprising the UID to the second client 140 by making use of an appropriate push protocol or a protocol that enables pushing information from the first client 120 to the second client 140.

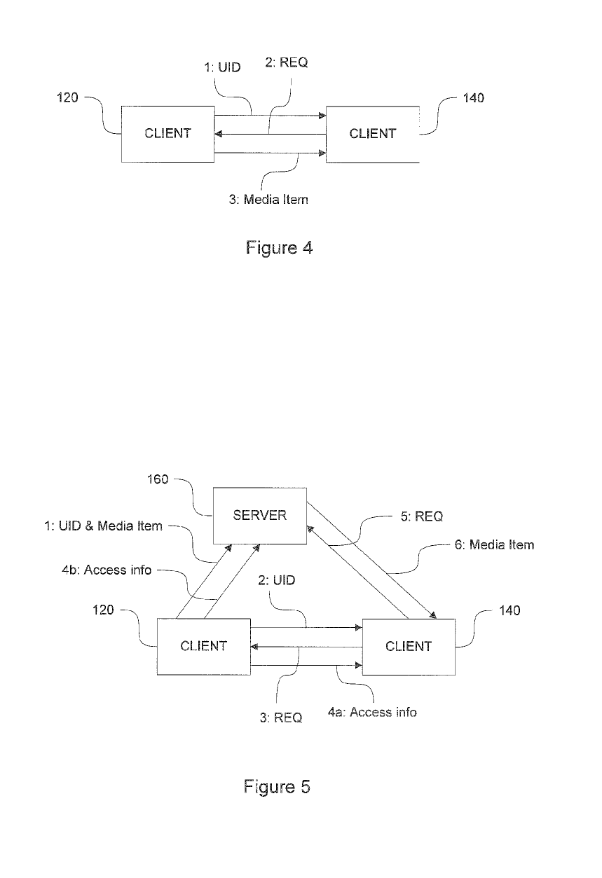

As briefly referred to hereinbefore, instead of providing the media item in parallel with the UID, the first client 120 may be configured to receive a request from the second client 140 for provision of the media item with which the UID is associated and providing, in response to the request, the media item to the second client 140, as schematically illustrated in FIG. 4. The media item may be provided by any communication means known in the art, e.g. in a MMS message, in an email message, by BT data exchange, by using NFC technology, over a HTTP connection, by means of a proprietary protocol for transferring the media item between the clients 120, 140, etc. In an example embodiment, the first client 120 may be configured to push the media item to the second client 140 in accordance with an appropriate push protocol or a protocol that enables pushing data from the from the first client 120 to the second client 140.

Instead of or in addition to providing the media item to the second client 140, according to an example embodiment the first client 120 may be configured to provide the media item, together with the UID, to the server 160. Provision of the media item and the UID associated therewith to the server 160 enables subsequent access to the media item by the first client 120 and/or by the second client 140 on basis of the UID. Thus, the media item provided to the server 160 may serve both as backup data for the first client 120 enabling a subsequent re-acquisition of the media item if needed, while at the same time the media item provided to the server 160 may enable making use of the server 160 as a distribution point for subsequently providing the media item to the second client 140 or further clients.

According to an example embodiment, assuming that the media item is available at the server 160, the first client 120 may be configured, in response to receiving a request from the second client 140 for provision of the media item associated with the UID, to provide the server 160 with an authorization indicative of the second client 140 being authorized to access the media item at the server 160, e.g. to download the media item from the server 160. The first client 120 and the server 160 may be configured to communicate, e.g. to exchange one or more messages, in order to determine access credentials for the second client 140 for it to be able to access the media item at the server 160.

As an example, the determination of access credentials may comprise e.g. the server 160 obtaining or determining the access credentials in accordance with a predefined policy and providing the obtained/determined access credentials to the first client 120 for provision to the second client 140. Alternatively, the determination of the access credentials may comprise the first client 120 obtaining or determining the access credentials and providing the obtained/determined access credentials to the server 160 to enable verifying the authorization of the access by the second client 140. If performed at the first client 120, the determination of the access credentials may comprise e.g. (automatic) determination of access credentials according to a predefined policy and/or based on input from a user of the first client 120.

As another example, the determination of the access credentials may comprise determining a (temporary) username and a password that may be used to access the media item at the server 160 or, alternatively, the determination may comprise determining a password useable with a known username of a user of the second client 140 to enable the second client 140 to access to the media item at the server 160.

According to an example embodiment, the first client 120 may be configured to provide the second client 140 with an indication on authorization for the second client 140 to access the media item at the server 160 once the access credentials have been determined. The indication may comprise the access credentials that enable the second client 140 to access the media item at the server 160. The indication may further comprise address information, e.g. a link or a hyperlink, or indication of other type identifying the server 160 and/or the media item at the server 160 to facilitate downloading the media item. Alternatively, the indication may be provided without a link or further address information explicitly identifying the server 160, and the second client 140 may employ a priori knowledge of the address of the server 160, or the second client 140 may receive or obtain the indication identifying the server and/or address thereof independently of the indication comprising the access credentials, possibly from a source different from the first client 120. The address information, together with the access credentials, may be used by the second client 140 to obtain the media item from the server 160, e.g. to receive the media item from the server 160 in response to a request provided thereto. The provision of the indication by the first client 120 may be realized in a manner similar to providing the UID from the first client 120 to the second client 140, e.g. by means of an appropriate push protocol or a protocol that enables pushing information from the server 160 to the second client 140. An example of the process of the second client 140 being provided with access credentials and the address information of the server 160 by the first client 120 is schematically illustrated in FIG. 5.

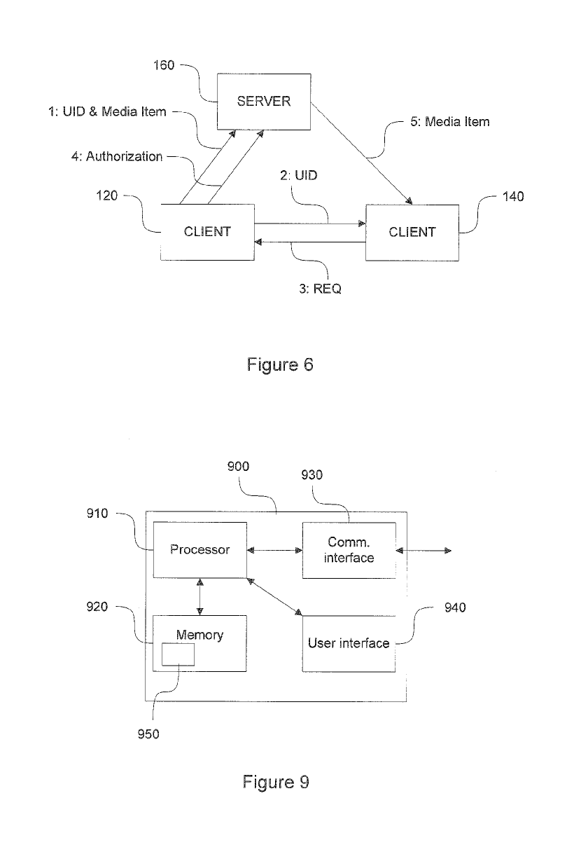

As another example, instead of the first client 120 and/or the server 160 determining the access credentials for the second client 140 to access the media item at the server 160, the server 160 may be configured to, in response to receiving the authorization indicative of the second client 140 being authorized to access the media item at the server 160, to provide the media item to the server, e.g. by using an appropriate push protocol or a protocol that enables pushing data from the from the server 160 to the second client 140. An example of the process of the second client 140 being provided with the media item by the server 160 in response to a request to the first client 120 is schematically illustrated in FIG. 6.

The second client 140 may be configured to obtain the UID, for example, by receiving the UID from the first client 120, as described hereinbefore. As another example, the second client 140 may be configured to receive the media item having the UID associated therewith in parallel with the UID from the first client 120, as also described hereinbefore. Alternatively, the second client 140 may receive the UID from another source, e.g. from another client, as input typed by a user of the second client 140, on basis of a query to or a search in a database in a server, e.g. in the server 160, etc. As a further example, the second client 140 may be further configured to receive information indicative of an association between the media item and the first client 120 and/or an association between the media item and a user of the first client 120.

Upon or after obtaining of the UID, if not having received the media item together with the UID, the second client 140 may be configured to determine whether a media item having the same UID value is already available at the second client 140. This determination may comprise a search through one or more directories and/or databases in the second client 140 or otherwise accessible by the second client 140 in order to identify a media item with a matching UID associated therewith. As an example, in case such media item is found to be already available at the second client 140, the second client 140 may be configured to associate said media item with the first client 120 and/or with a user of the first client 120. On the other hand, the second client 140 may be configured to request, in response to the media item with a matching UID value not being available at the second client 140, the media item corresponding to the obtained UID from the first client 120. The request may comprise an indication of the value of the UID associated with the requested media item. Alternatively, the request may comprise another identifier whose value implies and hence indirectly indicates the requested media item.

As described hereinbefore by way of example, in response to the request, the first client 120 may be configured to provide to the second client 140 with the media item having the UID indicated or implied in the request associated therewith. Alternatively, as also described hereinbefore, the first client 120 may be configured to provide to the second client 140, in response to the request, with an indication on an authorization for the second client 140 to access the requested media item at the server 160. The indication may comprise access credentials such as a password and possibly a username enabling access to the media item at the server 160, as described hereinbefore.

The second client 140 may be further configured, according to an example embodiment, in response to receiving the indication on authorization to access the media item at the server 160, to access the media item from the server 160, e.g. by downloading the media item from the server 160 in accordance with the address information provided to the second client 140 in the indication on the authorization to access the media item or on basis of address information identifying the server provided to the second client by other means. The downloading may comprise the second client requesting the media item from the server on basis of the access credentials received from the first client 120 and the server 160 providing the media item in response to the request in case the authentication based on the access credentials is successful.

Alternatively, instead of the first client 120 providing the second client 120 with the indication on the authorization to access the media item at the server 160, the first client 120 may authorize the server 160 to provide the media item to the second client 140, and the server 160 may, consequently, provide the media item to the second client, e.g. as described hereinbefore. Consequently, the second client 140 may be configured to obtain the media item from the server 160 in response to the request provided to the first client 120.

Having received the media item, either from the first client 120 or from the server 160, the second client 140 may be configured to store the media item at the second client 140 and to associate the media item with the first client 120 or a user thereof. The association may comprise automatically associating the received media item with the first client 120 and/or a user thereof or providing for manual association by e.g. prompting a user of the second client 120 to associate or accept association of the media item with the first client 120 or a user thereof.

While, for brevity and clarity of description, obtaining, providing and receiving a single UID is described hereinbefore by way of example, the description generalizes into obtaining, providing and/or receiving two or more UIDs within the same information exchange between the first client 120 and the second client 140, between the first client 120 and the server 160 and/or between the second client 140 and the server 160. Consequently, also provision of a single media item as described hereinbefore by way of example, generalizes into provision of two or more media items, each corresponding to one of the two or more UIDs, within the same information exchange between the first client 120 and the second client 140, between the first client 120 and the server 160 and/or between the second client 140 and the server 160.

Furthermore, while the description hereinbefore describes a single UID associated with a single media item, a single UID may be associated with one or more media items. Such a set of one or more media items having a single UID associated therewith may be provided in or as a folder or a similar archive type collection of media items that may contain any desired number of media items. As an example, such a set of one or more media items comprises one or more media types of similar type, e.g. one or more audio signals, one or more video signals, one or more images, or one or more text items. A client, for example the second client 140, may be configured to obtain all media items of such a set of media items for subsequent use. As another example, the client may be configured to randomly select and obtain a subset of one or more media items from a set of media items. In case the client as obtained at least two media items of a group having a given UID associated therewith, upon using a media item associated with the given UID the client may select a media item from the at least two media in accordance with a predetermined rule. The predetermined rule may involve e.g. using the two or more media items in a round-robin manner or randomly selecting a media item of the two or more media items for each occasion.

The operations, procedures and/or functions described in context of the first client 120, the second client 140 and the server 160 may be provided as means for carrying out the corresponding operations, procedures and/or functions assigned to the above-mentioned portions. Such means may be provided as software means, as hardware means, or as a combination of software means and hardware means.

As an example, the first client 120 may be provided as an apparatus comprising means for obtaining one or more media items associated with the first client 120 and/or a user, means for obtaining one or more unique identifiers, each associated with a media item of the one or more media items, and means for providing said one or more unique identifiers to at least one second client 140 to enable identification of the one or more media items on basis of the respective one or more unique identifiers.

Along similar lines, the second client 140 may be provided, for example, as an apparatus comprising means for obtaining one or more unique identifiers, each associated with a media item of one or more media items, wherein the one or more media items are associated with the first client 120 and/or a user, means for determining whether the one or more media items having said one or more unique identifiers associated therewith are already available for at least one second client 140 and/or user at the apparatus, means for requesting, in response to the one or more media items having said one or more unique identifiers associated therewith not being available at the apparatus, the one or more media item from the first client 120, and means for associating the media item with said first client 120 and/or user.

The operations, procedures and/or functions described hereinbefore by way of example in context of the first client 120, the second client 140 and/or the server 160 may also be expressed as steps of a method implementing the corresponding operation, procedure and/or function.

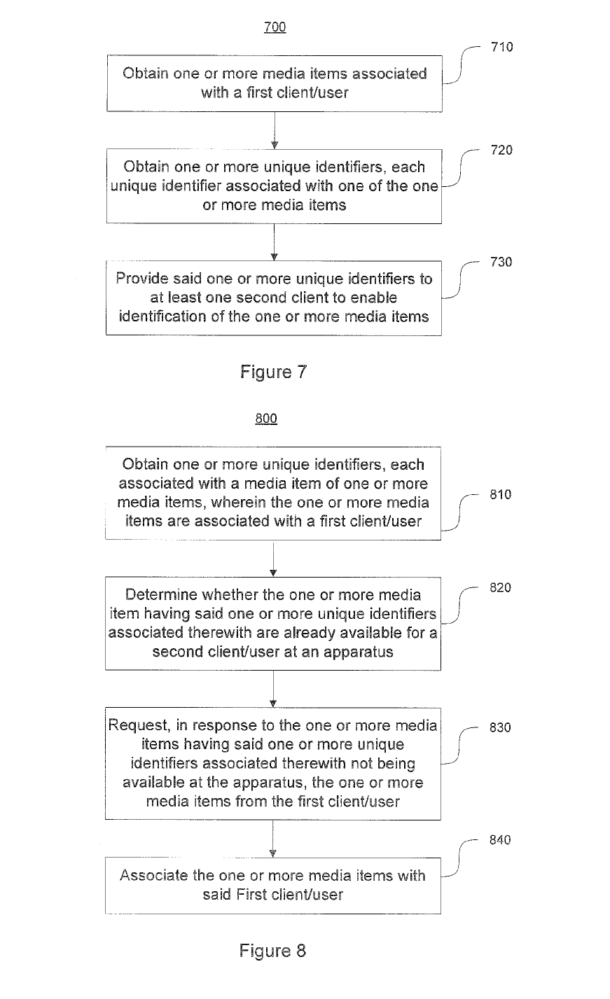

As an example in this regard, FIG. 7 illustrates a method 700. The method 700 comprises obtaining one or more media items associated with the first client 120, as indicated in block 710. The method 700 comprises obtaining one or more unique identifiers, each associated with a media item of the one or more media items, as indicated in block 720. The method 700 further comprises providing said one or more unique identifiers to at least one second client 140 to enable identification of the one or more media items, as indicated in block 730.

Exemplifying approaches for more detailed description regarding operations, procedures and/or functions within blocks 710 to 730 of the method 700 and possible further operations, procedures and/or functions that the method 700 may comprise is provided hereinbefore in context of the first client 120.

As another example, FIG. 8 illustrates a method 800. The method 800 comprises obtaining one or more unique identifiers, each associated with a media item of one or more media items, wherein the one or more media items are associated with the first client 120, as indicated in block 810. The method 800 comprises determining whether the one or more media items having said one or more unique identifiers associated therewith are already available for at least one second client 140 at an apparatus, as indicated in block 820. The method 800 further comprises requesting, in response to the one or more media items having said one or more unique identifiers associated therewith not being available for the at least one second client 140 at the apparatus, the one or more media items from the first client 120, as indicated in block 830. Finally, the method 800 comprises associating the one or more media items with said first client 120, as indicated in block 840. Exemplifying approaches for more detailed description regarding operations, procedures and/or functions within blocks 810 to 840 of the method 800 and possible further operations, procedures and/or functions that the method 800 may comprise is provided hereinbefore in context of the second client 140.

FIG. 9 schematically illustrates an exemplifying apparatus 900 upon which an embodiment of the invention may be implemented. The apparatus 900 as illustrated in FIG. 9 provides a diagram of exemplary components of an apparatus, which is capable of operating as or providing the first client 120, the second client 140 or the server 160 in the example arrangement 100 of FIG. 1 according to an embodiment. The apparatus 900 comprises a processor 910, a memory 920 and a communication interface 930, such as a network card or a network adapter enabling wireless or wireline communication with another apparatus and/or radio transceiver enabling wireless communication with another apparatus over radio frequencies. The processor 910 is configured to read from and write to the memory 920. The apparatus 900 may further comprise a user interface 940 for providing data, commands and/or other input to the processor 910 and/or for receiving data or other output from the processor 910, the user interface 940 comprising for example one or more of a display, a keyboard or keys, a mouse or a respective pointing device, a touchscreen, etc. The apparatus 900 may comprise further components not illustrated in the example of FIG. 9. As an example in this regard, the apparatus 900 may comprise audio capturing means, video capturing means and/or image capturing means, as described hereinbefore in context of the first client 120.

Although the processor 910 is presented in the example of FIG. 9 as a single component, the processor 910 may be implemented as one or more separate components. Although the memory 920 in the example of FIG. 9 is illustrated as a single component, the memory 920 may be implemented as one or more separate components, some or all of which may be integrated/removable and/or may provide permanent/semi-permanent/dynamic/cached storage.

The apparatus 900 may be embodied for example as a mobile phone, a digital camera, a digital video camera, a music player, a gaming device, a laptop computer, a desktop computer, a personal digital assistant (PDA), an internet tablet, a television set, etc.

The memory 920 may store a computer program 950 comprising computer-executable instructions that control the operation of the apparatus 900 when loaded into the processor 910. As an example, the computer program 950 may include one or more sequences of one or more instructions. The computer program 950 may be provided as a computer program code. The processor 910 is able to load and execute the computer program 950 by reading the one or more sequences of one or more instructions included therein from the memory 920. The one or more sequences of one or more instructions may be configured to, when executed by one or more processors, cause an apparatus, for example the apparatus 900, to implement the operations, procedures and/or functions described hereinbefore in context of the first client 120, the second client 140 or the server 160.

Hence, the apparatus 900 may comprise at least one processor 910 and at least one memory 920 including computer program code for one or more programs, the at least one memory 920 and the computer program code configured to, with the at least one processor 910, cause the apparatus 900 to perform the operations, procedures and/or functions described hereinbefore in context of the first client 120, the second client 140 or the server 160.

The computer program 950 may be provided at the apparatus 900 via any suitable delivery mechanism. As an example, the delivery mechanism may comprise at least one computer readable non-transitory medium having program code stored thereon, the program code which when executed by an apparatus cause the apparatus at least implement processing to carry out the operations, procedures and/or functions described hereinbefore in context of the first client 120, the second client 140 or the server 160. The delivery mechanism may be for example a computer readable storage medium, a computer program product, a memory device a record medium such as a CD-ROM or DVD, an article of manufacture that tangibly embodies the computer program 950. As a further example, the delivery mechanism may be a signal configured to reliably transfer the computer program 950.

Reference to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. An apparatus comprising at least one processor and at least one memory including computer program code for one or more programs, the at least one memory and the computer program code configured to, with the at least one processor, cause the apparatus to perform at least the following:
obtain one or more media items associated with a first client;
obtain one or more unique identifiers, each associated with at least one media item of the one or more media items; and
provide said one or more unique identifiers to at least one second client to enable identification of the one or more media items.

2. An apparatus according to claim 1, wherein providing said one or more unique identifiers further comprises providing information indicative of an association between said one or more media items and the first client.

3. An apparatus according to claim 1, wherein the apparatus is further caused to:
provide the one or more media items to the at least one second client in parallel with the one or more unique identifiers.

4. An apparatus according to claim 1, wherein the apparatus is further caused to
receive, from the at least one second client, a request to provide said one or more media items, and
provide said one or more media items to the at least one second client in response to the request.

5. An apparatus according to claim 1, wherein the apparatus is further caused to:
provide said one or more media items and the one or more unique identifiers to a server apparatus.

6. An apparatus according to claim 5, wherein the apparatus is further caused to
receive, from the at least one second client, a request to provide said one or more media items,
provide, in response to said request, the server apparatus with an authorization for the at least one second client to access the one or more media items at the server apparatus, and
provide the at least one second client with an indication on authorization to access the one or more media items at the server.

7. An apparatus according to claim 1, wherein obtaining the one or more unique identifiers comprises determining the one or more unique identifiers in accordance with a predetermined rule.

8-9. (canceled)

10. An apparatus according to claim 1, wherein a unique identifier is based at least in part on one or more characteristics of the respective at least one media item.

11. An apparatus according to claim 1, wherein a unique identifier is based at least in part on one or more characteristics associated with said first client.

12. An apparatus according to claim 1, wherein a unique identifier comprises a Universally Unique Identifier (UUID).

13. An apparatus according to claim 1, wherein the one or more media items are further associated with one or more specific services or applications.

14. An apparatus according to claim 13, wherein the one or more media items comprise a personalized ringing tone associated with said first client.

15. An apparatus according to claim 1, wherein the one or more unique identifiers are provided as one or more parameters of one or more vCard and/or xCard exchanges.

16. An apparatus according to claim 1, wherein the one or more unique identifiers are provided in one or more short message service (SMS) messages.

17. An apparatus according to claim 1, wherein the first client and the at least one second client are provided at the same apparatus.

18. An apparatus according to claim 1, wherein the first client and the at least one second client are provided at separate apparatuses.

19. An apparatus according to claim 1, wherein a unique identifier is associated with a single media item provided as one or more media files.

20. An apparatus according to claim 1, wherein a unique identifier is associated with two or more media items, each provided as one or more media files.

21. An apparatus comprising
means for obtaining one or more media items associated with a first client;
means for obtaining one or more unique identifiers, each associated with at least one media item of the one or more media items; and
means for providing said one or more unique identifiers to at least one second client to enable identification of the one or more media items.

22. (canceled)

23. A method comprising
obtaining one or more media items associated with a first client;
obtaining one or more unique identifiers, each associated with at least one media item of the one or more media items; and
providing said one or more unique identifiers to at least one second client to enable identification of the one or more media items.

24-44. (canceled)
